(19) United States
(12) Patent Application Publication
(10) Pub. No.: US 2006/0150850 A1
(43) Pub. Date: Jul. 13, 2006

(54) Method of tracing process printing fluids

(76) Inventors: John E. Hoots, St. Charles, IL (US); Martin R. Godfrey, Naperville, IL (US); Lars E. Capener, Aurora, IL (US); Dolores J. Soto, Rolling Meadows, IL (US)

Correspondence Address: Nalco Company;Patent & Licensing Department, 1601 W. Diehl Road, Naperville, IL, 60563-1198, US

(21) Appl. No.: 11/374,492

(22) Filed: Mar. 13, 2006

Related U.S. Application Data
(63) Continuation of application No. 10/767,762, filed on Jan. 29, 2004, now abandoned.

(51) Int. Cl. B41F 33/00

(52) U.S. Cl. 101/483

(57) ABSTRACT

A method of tracing process printing fluids is described and claimed. The process printing fluids are selected from the group consisting of One-Component Fountain Solutions, Two-Component Fountain Solutions and Web Release Agents. The tracer used is capable of being detected fluorometrically in each process printing fluid of interest.

### CROSS REFERENCE TO RELATED APPLICATIONS

This application is a continuation application of U.S. patent application Ser. No. 10/767,762, which was filed on Jan. 29, 2004.

### FIELD OF INVENTION

This invention is in the field of printing fluids. Specifically, this invention is in the field of the use of fluorescent tracers in Fountain Solutions and Web Release Agents that are used in various ways in different types of printing processes.

### BACKGROUND OF THE INVENTION

Printing fluids include Fountain Solutions and Web Release Agents. Fountain Solutions are used on an offset press to keep the ink from adhering to the non-image areas of the offset plate. There are seven key functions of a Fountain Solution:

1) Keep ink off the background with a film of water;

2) Maintain the hydrophilic nature of the background;

3) Quickly clean ink off the background during press starts;

4) Promote fast spreading of water over the plate surface;

5) Help the water flow evenly through the dampening rollers;

6) Lubricate the plate and blanket; and

7) Control emulsification of ink and water.

Fountain Solutions generally have five major parts:

a) Water, which comprises by far the largest portion of the Fountain Solution;

b) Acid, which reduces the pH, keeping the plate image area sensitive to ink as well as keeping the background areas sensitive to water;

c) Wetting agents, or surfactants, lower the surface tension of the water, allowing it to maintain the wetting characteristics of the non-printing areas (non-image areas) of the plate. By reducing the amount of water necessary to keep the plate clean, wetting agents also reduce the amount of ink required for printing. Isopropyl Alcohol is one of the most common wetting agents added;

d) Plate conditioners and other additives, which act to minimize the corrosive action of the acid on the aluminum plate. These act to extend plate life and improve the overall print quality; and

e) antifoam and anti-fungus agents are included in most Fountain Solutions.

Fountain Solutions may also contain buffering compounds to keep the solution acidic, non-piling agents (NPA) to eliminate any chance of piling, silicone materials to enhance the release characteristics of the blankets and minimize piling due to paper picking tendencies, etc; and Gum arabic. The gum function is to adhere to the plates' non-image area and protect it from accepting ink. Gum also serves to protect the plate from humidity and chemical attack during press stops. Today, some gum substitutes are being used such as CMC (carboxymethyl cellulose), etc. Gum arabic, however, is still the most effective material for keeping the non-image areas of the plate clean.

Web Release Agents provide sheet release by reducing the surface tension of the roll. A Web Release Agent is chemically a silicone-based (surfactant) mixture that provides for

a) remoisturizing of web,

b) lubrication of web,

c) reduction of web breakage,

d) prevention of marking,

e) protection of printed image,

f) static reduction, and

g) desired slippage.

In current printing practices, the primary ingredient in Web Release Agents is a silicone material selected from the group consisting of synthetic silicones, natural silicones, and a mixture of natural and synthetic silicones.

Monitoring and control of the use and application of printing fluids may be done by using techniques such as those described and claimed in U.S. Pat. No. 5,826,507, entitled, Method for Measuring the Amount of Fountain Solution in Offset Lithography Printing, which contains information on a method of determining the amount of a Fountain Solution employed in an offset lithography printing system in which a detectable substance is added to the Fountain Solution and the amount thereof detected in a target such as the ink rollers and/or the image and non-image areas of the printed paper, the amount of the detectable substance being related to the amount of Fountain Solution employed in the offset lithography process. Neither the chemical composition of the dilute Fountain Solution or the amount of Fountain Solution present in the dilution tank are measured or controlled by this invention.

In U.S. Pat. No. 5,826,507, the testing for the non-fluorescent tracer material, lithium chloride, is off line, non continuous and requires a lengthy manual sample preparation procedure. Therefore it could not be performed in real time or used for immediate control of the printing process.

UK Patent Application GB 2254917 describes and claims a device for determining the thickness of a dampening-medium fluid film on the surface of a print form of an offset printing machine wherein a fluorescent medium of a certain concentration is added to the fluid film and excited using a UV laser to fluoresce on the surface of the print form. The fluorescent radiation is detected and its intensity is used to measure the thickness of the fluid film. The exciting radiation may be modulated.

The system in UK Patent Application GB 2254917 is used to control a mechanical adjustment on the printing press not the chemical composition of the Fountain Solution. Fluorophore addition to the Fountain Solution is only controlled to enable the film thickness measurement and not as a means to control the chemical composition of the Fountain Solution. The automatic control of the Fountain Solution composition only applies to the fluorophore. The fluorophore is not added with the other chemicals and does not control the addition of the other chemicals to the system.

It would be desirable to have an additional method for determining whether the desired amount of printing fluid is located in the part of the printing process where it is supposed to be.

### SUMMARY OF THE INVENTION

The first aspect of the instant claimed invention is a method of tracing process printing fluids, comprising the steps of:
1) providing a printing process wherein one or more process printing fluids are in use; wherein said process printing fluids are selected from the group consisting of Fountain Solutions and Web Release Agents;
2) providing a tracer material, capable of being detected fluorometrically, for each process printing fluid of interest, wherein each tracer material, being added to each process printing fluid of interest, has a detectable fluorescent signal;
3) providing one or more fluorometers capable of detecting the fluorescent signals of each tracer material being used within the process printing fluids of interest;
4) locating said one or more fluorometers in any location within the printing process where it is desired to detect the presence or absence of the process printing fluid of interest, except that the location cannot be selected to measure the process printing fluid on the paper itself;
5) using said one or more fluorometers to detect and measure the fluorescent signal of said tracer materials in one or more locations within the printing process;
6) using the detected and measured fluorescent signals of said tracer materials to determine how much of each of the process printing fluids is present in the selected location in the printing process; and optionally
7) adjusting the operating parameters of said printing process such that the amount of process printing fluid present at the locations of interest is optimized.

### DETAILED DESCRIPTION OF THE INVENTION

Throughout this patent application the following terms have the indicated definitions:

“aka” means also known as;

“Anchor” refers to Anchor, 50 Industrial Loop, North, Orange Park. Fla., 800-354-2300;

“capable of being detected” means a fluorescent signal that is at least about five times larger than the fluorescent signals of the background materials present;

“CAS Registry No.” refers to the Chemical Abstracts Services Registry Number;

“C & W” refers to C & W Unlimited, 217-A Washington Avenue, Carlstadt, N.J. 201-933-4343;

“ICM” refers to ICM Products, Inc., 805 Wolfe Avenue, Cassopolis, Minn. 49031, 616-445-0847;

“Nalco” refers to Nalco Company, 1601 W. Diehl Road, Naperville Ill. 60563, telephone number (630) 305-1000;

“PFSF” refers to purchased Fountain Solution formula;

“PWRA” refers to purchased web release agent;

“RBP” refers to rbp Chemical Technology, 150 South 118^{th} Street, Milwaukee, Wis., 53214, telephone number 414-258-7908; and

“Rycoline” refers to Rycoline Products, Inc., 5540 N. Northwest Highway, Chicago, Ill., 60630, 800-621-1003;

The first aspect of the instant claimed invention is a method of tracing process printing fluids, comprising the steps of:
1) providing a printing process wherein one or more process printing fluids are in use; wherein said process printing fluids are selected from the group consisting of Fountain Solutions and Web Release Agents;
2) providing a tracer material, capable of being detected fluorometrically, for each process printing fluid of interest, wherein each tracer material, being added to each process printing fluid of interest, has a detectable fluorescent signal;
3) providing one or more fluorometers capable of detecting the fluorescent signals of each tracer material being used within the process printing fluids of interest;
4) locating said one or more fluorometers in any location within the printing process where it is desired to detect the presence or absence of the process printing fluid of interest, except that the location cannot be selected to measure the process printing fluid on the paper itself;
5) using said one or more fluorometers to detect and measure the fluorescent signal of said tracer materials in one or more locations within the printing process;
6) using the detected and measured fluorescent signals of said tracer materials to determine how much of each of the process printing fluids is present in the selected location in the printing process; and optionally
7) adjusting the operating parameters of said printing process such that the amount of process printing fluid present at the locations of interest is optimized.

The process printing fluids that can be traced using the method of the instant claimed invention are selected from the group consisting of Fountain Solutions and Web Release Agents.

Fountain Solutions are formulated to meet the specific needs of the print job, such that all components may vary in concentration, and in some cases, may not be required in the Fountain Solution. The group of Fountain Solutions useful in the method of the instant claimed invention is usually divided between One-Component Fountain Solutions and Two-Component Fountain Solutions. One-Component Fountain Solutions typically contain the following ingredients: water, acid, wetting agents (surfactants and/or isopropyl alcohol), buffers, plate conditioners and gum arabic or carboxymethyl cellulose. One-Component Fountain Solutions are different than Two-Component Fountain Solutions because they contain all of these ingredient in one solution, whereas Two-Component Fountain Solutions divide the ingredients into an acid solution and a wetting agent solution.

Suitable commercially available One-Component Fountain Solutions for use in the method of the instant claimed invention, include the following:

Mild Acid Fountain Soln. 990 NRO from C&W Unlimited;

BPC ETCH HW 264724-330P from Rycoline;

2953 Quad Special Etch Single-Part Acid Fountain Solution from Anchor;

2150 Emerald Premium WCNP High Speed Web Acid Fountain Solution from Anchor;

20231 Emerald Premium KDMV-V from Anchor; and

20180 Emerald Premium QRKW from Anchor.

Two-Component Fountain Solutions typically contain the following ingredients: water, acid, wetting agents (surfactants and/or isopropyl alcohol), buffers, plate conditioners and gum arabic or carboxymethyl cellulose. The first component of a Two-Component Fountain Solution consists of water, acid and buffers. The second component of a Two-Component Fountain Solution contains water, the wetting agents, and any other conditioning agents. Two-Component Fountain Solutions are different than One-Component Fountain Solutions because the ingredients are divided between an acid solution and a wetting agent solution.

Suitable commercially available Two-Component Fountain Solutions include the Concept 21 System from RBP; with the two components being described as follows:

Concept 21 ADM 2.0 is an acidic desensitizing modifier. It addresses plate sensitivity problems such as tinting, toning and scumming. It is the acid source for the Fountain Solution. For purposes of the instant claimed invention this material would be the First Component of a Two-Component Fountain Solution.

Concept 21 STM 2.0 is a surface tension modifier and contains the wetting and conditioning agents for the system. For purposes of the instant claimed invention this material would be the Second Component of a Two-Component Fountain Solution.

The two components of the Concept 21 system, or any other commercially available Two-Component Fountain Solution are formulated to allow for independent adjustment of plate sensitivity and surface tension characteristics of the Fountain Solution and allows the printer to customize the Fountain Solution to a particular print job depending on paper, ink, plates, dampening system and other factors.

Tracers suitable for One-Component Fountain Solutions are selected from the group consisting of 2-anthracenesulfonic acid sodium salt (CAS Registry No. 16106-40-4), 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof,

see U.S. patent application Ser. No. 10/631,606, filed Jul. 31, 2003, entitled “Use of Disulfonated Anthracenes as Inert Fluorescent Tracers”, now pending, which is incorporated by reference in its entirety;

anthra[9,1,2-cde]benzo[rst]pentaphene-5,10-diol, 16,17-dimethoxy-, bis(hydrogen sulfate), disodium salt, aka Anthrasol Green IBA (CAS Registry No. 2538-84-3), aka Solubilized Vat Dye,

bathophenanthrolinedisulfonic acid disodium salt (CAS Registry No. 5274649-3),

1H-benz[de]isoquinoline-5-sulfonic acid, 6-amino-2,3-dihydro-2-(4-methylphenyl)-1,3-dioxo-, monosodium salt, aka Brilliant Acid Yellow 8G (CAS Registry No. 2391-30-2), aka Lissamine Yellow FF, Acid Yellow 7,

benzo[a]phenoxazin-7-ium, 5,9-diamino-, acetate, aka cresyl violet acetate (CAS Registry No. 10510-54-0),

1-ethylquinaldinium iodide (CAS Registry No. 606-53-3),

Keyfluor White ST (CAS Registry No. 4193-55-9), aka Flu. Bright 28,

benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Keyfluor White CN (CAS Registry No. 16470-24-9),

9,9′-biacridinium, 10,10′-dimethyl-, dinitrate, aka Lucigenin (CAS Registry No. 2315-97-1, aka bis-N-methylacridinium nitrate),

1-deoxy-1-(3,4-dihydro-7,8-dimethyl-2,4-dioxobenzo[g]pteridin-10(2H)-yl)-D-ribitol, aka Riboflavin or Vitamin B2 (CAS Registry No. 83-88-5),

mono-, di-, or tri-sulfonated napthalenes, including but not limited to:

2-amino-1-naphthalenesulfonic acid (CAS Registry No. 81-16-3),
5-amino-2-naphthalenesulfonic acid (CAS Registry No. 119-79-9),
7-amino-1,3-naphthalenesulfonic acid, potassium salt (CAS Registry No. 79873-35-1),
5-dimethylamino-1-naphthalenesulfonic acid (CAS Registry No. 4272-77-9),
1-amino-4-naphthalene sulfonic acid (CAS Registry No. 84-86-6),
   1-amino-7-naphthalene sulfonic acid (CAS Registry No. 119-28-8), and
   benzenesulfonic acid, 2,2′-(1,2-ethenediyl)bis[5-(4-phenyl-2H-1,2,3-triazol-2-yl)-, dipotassium salt, aka Phorwite BHC 766 (CAS Registry No. 52237-03-3),
   benzenesulfonic acid, 5-(2H-naphtho[1,2-d]triazol-2-yl)-2-(2-phenylethenyl)-, sodium salt, aka Pylaklor White S-15A (CAS Registry No. 6416-68-8),
   1,3,6,8-pyrenetetrasulfonic acid, tetrasodium salt (CAS Registry No. 59572-10-0),
   quinoline (CAS Registry No. 91-22-5),
   xanthylium, 9-(2,4-dicarboxyphenyl)-3,6-bis(diethylamino)-, chloride, disodium salt, aka Rhodamine WT (CAS Registry No. 37299-86-8),
   phenazinium, 3,7-diamino-2,8-dimethyl-5-phenyl-, chloride, aka Safranine 0 (CAS Registry No. 477-73-6),
   benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, aka Sandoz TH-40 (CAS Registry No. 32694-954),
   xanthylium, 3,6-bis(diethylamino)-9-(2,4-disulfophenyl)-, sodium salt, aka Sulforhodamine B (CAS Registry No. 3520-42-1, aka Acid Red 52),
   benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, aka Tinopal 5BM-GX (CAS Registry No. 169762-28-1),
   benzenesulfonic acid, 2,2′-([1,1′-biphenyl]-4,4′-diyldi-2,1-ethenediyl)bis-, disodium salt aka Tinopal CBS-X (CAS Registry No. 27344-41-8), and
   7-benzothiazolesulfonic acid, 2,2′-(1-triazene-1,3-diyldi-4,1-phenylene)bis[6-methyl-, disodium salt, aka Titan Yellow (CAS Registry No. 1829-00-1, aka Thiazole Yellow G).

The preferred tracers for use with One-Component Fountain Solutions are selected from the group consisting of 2-anthracenesulfonic acid sodium salt (CAS Registry No. 16106-40-4), 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof,

anthra[9,1,2-cde]benzo[rst]pentaphene-5,10-diol, 16,17-dimethoxy-, bis(hydrogen sulfate), disodium salt, aka Anthrasol Green IBA (CAS Registry No. 2538-84-3, aka Solubilized Vat Dye),

Keyfluor White ST (CAS Registry No. 4193-55-9, aka Flu. Bright 28),

benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Keyfluor White CN (CAS Registry No. 16470-24-9),

1-deoxy-1-(3,4-dihydro-7,8-dimethyl-2,4-dioxobenzo[g]pteridin-10(2H)-yl)-D-ribitol, aka Riboflavin or Vitamin B2 (CAS Registry No. 83-88-5),

benzenesulfonic acid, 2,2′-(1,2-ethenediyl)bis[5-(4-phenyl-2H-1,2,3-triazol-2-yl)-, dipotassium salt, aka Phorwite BHC 766 (CAS Registry No. 52237-03-3),

benzenesulfonic acid, 5-(2H-naphtho[1,2-d]triazol-2-yl)-2-(2-phenylethenyl)-, sodium salt, aka Pylaklor White S-15A (CAS Registry No. 6416-68-8),

1,3,6,8-pyrenetetrasulfonic acid, tetrasodium salt (CAS Registry No. 59572-10-0),

xanthylium, 9-(2,4-dicarboxyphenyl)-3,6-bis(diethylamino)-, chloride, disodium salt, aka Rhodamine WT (CAS Registry No. 37299-86-8),

phenazinium, 3,7-diamino-2,8-dimethyl-5-phenyl-, chloride, aka Safranine 0 (CAS Registry No. 477-73-6),

benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, aka Sandoz TH40 (CAS Registry No. 32694-954),

xanthylium, 3,6-bis(diethylamino)-9-(2,4-disulfophenyl)-, sodium salt, aka Sulforhodamine B (CAS Registry No. 3520-42-1, aka Acid Red 52),

benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, aka Tinopal 5BM-GX (CAS Registry No. 169762-28-1), and

benzenesulfonic acid, 2,2′-([1,1′-biphenyl]-4,4′-diyldi-2,1-ethenediyl)bis-, disodium salt aka Tinopal CBS-X (CAS Registry No. 27344-41-8).

The most preferred tracers for use with One-Component Fountain Solutions are selected from the group consisting of 2-anthracenesulfonic acid sodium salt (CAS Registry No. 16106-40-4), 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; and 1,3,6,8-pyrenetetrasulfonic acid, tetrasodium salt (CAS Registry No. 59572-10-0).

The tracer which is compatible both with Web Release Agents and One-Component Fountain Solutions is anthracene disulfonic acid, disodium salt. The preferred combination of anthracene disulfonic acid salts is a mixture of the 1,5- and 1,8-isomers.

Tracers suitable for use with the First Component of a Two-Component Fountain Solution are selected from the group consisting of 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; 1,3,6,8-pyrenetetrasulfonic acid, tetrasodium salt (CAS Registry No. 59572-10-0). and 1,5-naphthalenedisulfonic acid, disodium salt (hydrate) (CAS Registry No. 1655-29-4), aka 1,5-NDSA hydrate, and benzenesulfonic acid, 2,2′-([1,1′-biphenyl]4,4′-diyldi-2,1-ethenediyl)bis-, disodium salt aka Tinopal CBS-X (CAS Registry No. 2734441-8).

Tracers suitable for use with the Second Component of a Two-Component Fountain Solution are selected from the group consisting of 1,5-naphthalenedisulfonic acid, disodium salt (hydrate) (CAS Registry No. 1655-29-4), aka 1,5-NDSA hydrate, xanthylium, 9-(2,4-dicarboxyphenyl)-3,6-bis(diethylamino)-, chloride, disodium salt, aka Rhodamine WT (CAS Registry No. 37299-86-8), and xanthylium, 3,6-bis(diethylamino)-9-(2,4-disulfophenyl)-, sodium salt, aka Sulforhodamine B (CAS Registry No. 3520-42-1, aka Acid Red 52).

Tracer pairs that are suitable for situations in which it is desired to trace both the First Component of a Two-Component Fountain Solution and the Second Component of a Two-Component Fountain Solution are shown in the following table.

| Component | Tracer | Tracer | Tracer | Tracer |
|---|---|---|---|---|
| First | ADSA | PTSA | ADSA | Tinopal CBS-X |
| Component | | | | |
| Second | NDSA | NDSA | Rhodamine WT | Sulforhodamine B |
| Component | | | | |
| In this table, “ADSA” is a compound selected from the group consisting of 1,5-anthracenedisulfonic acid (CAS Registry No. 61736-91-2) and salts thereof, | | | | |
| # 2,6-anthracenedisulfonic acid (CAS Registry No. 61736-95-6) and salts thereof, 1,8-anthracenedisulfonic acid (CAS Registry No. 61736-92-3) and salts thereof; and mixtures thereof, | | | | |

“PTSA” refers to 1,3,6,8-pyrenetetrasulfonic acid, tetrasodium salt (CAS Registry No. 59572-10-0).
“NDSA” refers to 1,5-naphthalenedisulfonic acid, disodium salt (hydrate) (CAS Registry No. 1655-29-4), aka 1,5-NDSA hydrate,
“Tinopal CBS-X” refers to benzenesulfonic acid, 2,2′-([1,1′-biphenyl]-4,4′-diyldi-2,1-ethenediyl)bis-, disodium salt aka Tinopal CBS-X (CAS Registry No. 27344-41-8),
“Rhodamine WT” refers to xanthylium, 9-(2,4-dicarboxyphenyl)-3,6-bis(diethylamino)-, chloride, disodium salt, aka Rhodamine WT (CAS Registry No. 37299-86-8),
“Sulforhodamine B” refers to xanthylium, 3,6-bis(diethylamino)-9-(2,4-disulfophenyl)-, sodium salt, aka Sulforhodamine B (CAS Registry No. 3520-42-1, aka Acid Red 52).

Tracers suitable for use with Web Release Agents are selected from the group consisting of 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; and mixtures thereof,

sulfonated amino-stilbene fluorescent brighteners and salts thereof, including, but not limited to:

benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Sandoz CD (CAS Registry No. 16470-24-9), aka Flu. Bright. 220,
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, (CAS Registry No. 32694-95-4), aka Sandoz TH-40,
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, (CAS Registry No. 169762-28-1), aka Tinopal 5BM-GX, and
   sulfonated bi-stilbene fluorescent brighteners and salts thereof, including, but not limited to:
4′,4′-bi[stilbene-2,2″′-disulfonate]disodium salt (CAS Registry No. 27344-41-8), aka Tinopal CBS, and
   alkylamino-coumarin fluorescent brighteners and salts thereof, including, but not limited to:
4-methyl-7-(diethylamino)-4-methylcoumarin (CAS Registry No. 91-44-1), aka Fluorescent Brightener 52.

The preferred tracers for use with Web Release Agents are selected from the group consisting of 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; and mixtures thereof, sulfonated amino-stilbene fluorescent brighteners and salts thereof, including, but not limited to:
benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Sandoz CD (CAS Registry No. 16470-24-9), aka Flu. Bright. 220,
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, (CAS Registry No. 32694-95-4), aka Sandoz TH-40,
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, (CAS Registry No. 169762-28-1), aka Tinopal 5BM-GX, and
benzenesulfonic acid, 5-(2H-naphtho[1,2-d]triazol-2-yl)-2-(2-phenylethenyl)-, sodium salt, (CAS Registry No. 6416-68-8), aka Tinopal RBS 200.

The most preferred tracers for use with Web Release Agents are selected from the group consisting of 1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; and mixtures thereof.

The fluorescent tracers listed above are commercially available from a variety of different chemical supply companies or are capable of being synthesized using techniques known to people of ordinary skill in the art of synthetic organic chemistry.

The amount of tracer typically present in a One-Component Fountain Solution is from about 0.01 ppm to about 10,000 ppm, preferably from about 0.05 ppm to about 10 ppm and most preferably from about 0.1 ppm to about 1.0 ppm.

The amount of tracer typically present in the first part of a Two-Component Fountain Solution is from about 0.01 ppm to about 10,000 ppm, preferably from about 0.05 ppm to about ppm and most preferably from about 0.1 ppm to about 1.0 ppm. The amount of tracer typically present in the second part of a Two-Component Fountain Solution is from about 0.01 ppm to about 10,000 ppm, preferably from about 0.05 ppm to about 10 ppm and most preferably from about 0.1 ppm to about 1.0 ppm.

The amount of tracer typically present in a Web-Release Agent is from about 0.01 ppm to about 10,000 ppm, preferably from about 0.05 ppm to about 10 ppm and most preferably from about 0.1 ppm to about 1.0 ppm.

Suitable fluorometers for use to detect tracers in Fountain Solutions are commercially available and are selected from the group consisting of TRASAR 8000 fluorometer (“hand-held”); TRASAR 700 fluorometer (“Bench-top”); TRASAR 3000 (for 1,3,6,8-pyrenetetrasulfonic acid, tetra sodium salt and any fluorescent compounds with similar excitation and emission wavelengths); modified TRASAR 3000 (for anthracene disulfonic acid, disodium salt and any fluorescent compounds with similar excitation and emission wavelengths); and the TRASAR Xe-2 Controller; which are all available from Nalco; and the In-Line fluorometer probe, known as the Cyclops 7 fluorometer (optical filters would need to be chosen to match the tracer used) available from Turner Designs, 845 Maude Ave., Sunnyvale, Calif. 94085 ((408) 749-0994). In order to make use of these fluorometers the excitation and emission optical filters will need to be chosen to match up with the fluorescent signal properties of the tracer.

Suitable fluorometers for use to detect tracers in Web Release Agents are commercially available and are selected from the group consisting of TRASAR 700 fluorometer (“Bench-top”); TRASAR 3000 (for 1,3,6,8-pyrenetetrasulfonic acid, tetra sodium salt and any fluorescent compounds with similar excitation and emission wavelengths); modified TRASAR 3000 (for anthracene disulfonic acid, disodium salt and any fluorescent compounds with similar excitation and emission wavelengths). In order to make use of these fluorometers the excitation and emission optical filters will need to be chosen to match up with the fluorescent signal properties of the Tracer.

The practical place to locate the fluorometers is such that they are capable of examining a sample of the material in the dilution tank for each of the printing process fluids of interest. In practice, both Fountain Solutions and web release agents are diluted in tanks; therefore locating the fluorometer to sample from the dilution tank applies equally to both fluids.

For printing processes where the method of the instant claimed invention is practiced, the standard equipment set-up is typically such that the printing fluid is supplied to the printing press using a pump and a pressurized line. For grab-sample fluorometry, a sample of the printing fluid for the fluorometer could be removed from this pressurized line. For grab-sample fluorometry, the Trasar 700 fluorometer and Trasar 8000 fluorometers do not have flow cells, rather they measure one discrete sample at a time wherein the samples are provided in discrete quantities obtained using a “grab sample” technique.

For flow-cell fluorometry appropriate pipe connections, with optional pump, could be added such that a sample of the printing fluid of interest would be circulated from the pressurized pipeline through the fluorometer. For flow-cell fluorometry, the Trasar Xe-Controller and Trasar 3000 fluorometers have flow cells that permit on-line continuous monitoring of a liquid.

Depending on the control system for applying the printing fluid to the press, installing a separate pump for circulation of the process printing fluid of interest to the fluorometer may be a preferred type of equipment set-up in order to avoid any adverse consequences, like pressure drop or siphoning, that may be caused by tapping into the pressurized printing fluid line. After circulation through the fluorometer the printing fluid would be returned to the dilution tank so that it would not be wasted. For this type of equipment setup, with the amount of recycle that will take place of the fluorometer sample stream, the most preferred location of the fluorometer would be in close proximity to the dilution tank. Locating the fluorometer in close proximity to the dilution tank would probably also be most convenient for operators of the printing process.

The positioning of the fluorometer is most strongly influenced by the sampling considerations since the information components of the control process can be transmitted electronically over long distances. For all of the flow-cell fluorometers suitable for use in the instant claimed invention, the signals from the fluorometer can be easily transmitted to remote locations as needed by the use of a 4-20 mA output. It is also possible to apply a control system where the setpoint for the amount of printing process fluid in the dilution tank could also be controlled remotely. Remote adjustment of setpoint is not necessarily a standard feature of commercially available fluorometers, but remote adjustment can be implemented easily with the use of a supplemental programmable logic controller, that is itself commercially available.

For all of the non-flow cell discrete grab sample fluorometers suitable for use in the instant claimed invention, the signal from the fluorometer can be manually entered into a controller for use within a control system.

The following examples are presented to be illustrative of the present invention and to teach one of ordinary skill how to make and use the invention. These examples are not intended to limit the invention or its protection in any way.

### EXAMPLES

### Example One

### Method of Tracing a One-Component Fountain Solution

The Cintra company prints a daily newspaper for a city located on the banks of the Elaina river. The Cintra company uses a 4 color offset press to print the publication on newsprint paper. The press uses a Fountain Solution. The Fountain Solution is prepared for use on the press by dilution of a purchased Fountain Solution formula (“PFSF”) with city water.

The raw source for the city water is the Elaina river. The PFSF is BPC Etch HW, 264724-330P purchased from Rycoline Products Inc. The PFSF is to be diluted to 5 ounces per gallon (3.9%) before use on the press. The dilution system for the PFSF employs a tank, a pump for the PFSF, a mechanical mixer, and a conductivity controller. The tank is equipped with a level control device that senses the level in the tank and opens or closes a valve allowing city water to enter the tank and maintain a constant level. The mixer constantly stirs the contents of the tank to assure a homogeneous solution.

The conductivity controller measures the conductivity of the diluted solution in the tank and turns on the PFSF pump when it drops below a lower control limit. The conductivity controller then turns off the PFSF pump when the conductivity of the solution reaches an upper control limit. Some diluted Fountain Solution recycling from the press also returns to this mixing tank. The goal of using the automated dilution system is to produce a continuous supply of the PFSF printing fluid at a constant and controlled dilution.

At the end of printing an issue of the newspaper where the print quality is optimal, heavy rain begins to fall on the watershed of the Elaina River. The printers encounter problems with print quality during the production of the next issue of the newspaper. They trace these problems to improper dilution of the PFSF. The root cause of the problems is a change in the city water quality.

The heavy rain has caused the Elaina River to rise and the conductivity of its water, and in turn the conductivity of the city water supply, to drop dramatically. The automated dilution system compensates for the drop in the city water conductivity by adding more of the PFSF to the dilution tank, thereby maintaining the total conductivity of the solution at the setpoint. The increased addition of PFSF creates a more concentrated Fountain Solution than desired. The improper dilution of the PFSF creates print quality problems.

In response to the failure of the conductivity controlled automatic dilution system the Cintra company implements the present invention. 20 ppm of a 2:1 mixture of 1,5-anthracene disulfonic acid disodium salt and 1,8-anthracene disulfonic acid disodium salt is added to the PFSF to act as a fluorescent tracer.

The dilution system for the PFSF is modified by removal of the conductivity controller. The on/off switch for the PFSF pump is now controlled by a TRASAR 3000 fluorometer, which has been modified by use of a 430AF30 emission filter for maximum sensitivity towards the anthracene disulfonic acid fluorescent tracer.

A sample from the PFSF dilution tank is continuously recirculated through the optical cell of the fluorometer and back to the dilution tank. The fluorometer detects the fluorescent signal from the fluorescent tracer and converts it to a concentration reading based on a calibration performed with a standard dilution of the tracer or a standard dilution of the traced printing fluid.

For the desired five ounces per gallon (3.9%) dilution of the PFSF a setpoint equivalent to 0.78 ppm anthracene disulfonic acid disodium salt is used.

Use of a +/−0.05 ppm (+/−0.32 ounces/gallon) control range means that the PFSF pump is activated at a concentration of 0.73 ppm as anthracene disulfonic acid disodium salt and that the pump is deactivated when the anthracene disulfonic acid disodium salt concentration in the dilution tank reaches 0.83 ppm.

When the concentration of PFSF as determined by the fluorometer drops below a lower control limit the fluorometer turns on the PFSF feed pump by actuation of an electric relay to add additional PFSF to the dilution tank. When the concentration of PFSF reaches an upper control limit the fluorometer turns off the PFSF pump.

Because the fluorescent signal of the tracer is entirely independent of city water quality the fluorometric controller maintains a constant dilution of the PFSF regardless of changes in the city water supply. Printing fluid dilution is removed as a source of variation in the printing process and print quality is more consistent and more easily optimized by the printers who man the press.

### Example 2

### A Method of Tracing a Web Release Agent

The Lorika Company prints a magazine using a 4 color offset press. The press uses a Fountain Solution and a Web Release Agent. Both the Fountain Solution and Web Release Agent are prepared for use on the press by dilution of PFSF and PWRA formula with city water. The city water supply is treated water from Lake EEB.

The PFSF is BPC Etch HW, 264724-330P purchased from Rycoline Products Inc. and diluted using the present invention as described in the previous example.

The PWRA formula is ICM 1741, available from ICM. The PWRA is to be diluted to 5% before use on the press. The existing dilution system for the PWRA employs an eductor, a mixing tank and a mechanical mixer. The tank is equipped with a level control device that senses the level in the tank and opens or closes a valve allowing city water to enter the tank and maintain a constant level. Before entering the tank the city water flows through the eductor and draws the PWRA into the flowing stream. The mixer constantly stirs the contents of the tank to assure a homogeneous solution. Diluted Web Release Agent recycling from the press is also returned to the mixing tank.

The goal of using the eductor dilution system is to produce a continuous supply of the Web Release Agent at a constant dilution. However, the eductor is not a high precision device and the dilution ratio it produces can depend on factors such as city water pressure, viscosity of the PWRA, the temperature of the fluids and fouling of the eductor tubing. The dilution ratio provided by the eductor is not easily adjusted or amenable to automated control so any adjustments to the concentration of PWRA are performed by manual addition of the PWRA to the dilution tank. As a consequence of these factors the Web Release Agent is commonly at higher than necessary concentration in the dilution tank and this situation is wasteful since the PWRA is a high cost specialty chemical.

In order to gain better control over PWRA dilution and to minimize the usage and cost of the PWRA the Lorika Company implements the method of the instant claimed invention.

100 ppm of a 2:1 mixture of 1,5-anthracene disulfonic acid disodium salt and 1,8-anthracene disulfonic acid disodium salt is added to the PWRA to function as a fluorescent tracer. The dilution system for the PWRA is modified by removal of the eductor which is replaced by an electric pump that injects PWRA into the mixing tank.

The PWRA pump is controlled by a TRASAR 3000 fluorometer, modified by using a 430AF30 emission filter for maximum sensitivity towards the anthracene disulfonic acid fluorescent tracer. A sample from the dilution tank is continuously recirculated through the optical cell of the fluorometer and back to the dilution tank. The fluorometer detects the fluorescent signal from the fluorescent tracer and converts it to a concentration reading based on a calibration performed with a standard dilution of the traced printing fluid.

A control range of ±0.05 ppm means that the PWRA pump is activated at a concentration of 4.95 ppm anthracene disulfonic acid disodium salt and deactivated at a concentration of 5.05 ppm anthracene disulfonic acid disodium salt.

When the concentration of PWRA as determined by the fluorometer drops below a lower control limit the fluorometer sends a signal to turn on the PWRA feed pump by actuation of an electric relay to add additional PWRA to the dilution tank. When the concentration of PWRA reaches an upper control limit the fluorometer turns off the PWRA pump. Use of a setpoint corresponding to 5 ppm of anthracene disulfonic acid disodium salt provides the proper 5% dilution for the PWRA.

Use of the method of the instant claimed invention provides continuous and reliable control of the dilution of the PWRA. If changes in the dilution become necessary they can be implemented quickly and easily by simply changing the setpoint of the fluorometer/controller. Reliable control enables the printers to optimize the concentration of PWRA used in the system and minimize the cost to purchase this specialty chemical. Dilution of PWRA is removed as a source of variation in the printing process and print quality is more consistent and more easily optimized by the printers who man the press.

The present method has been described in an illustrative manner. Many modifications and variations are possible in light of the above teachings. It is, therefore, to be understood that within the scope of the appended claims the invention may be practiced otherwise than as specifically described.

What is claimed is:

1. A method of tracing process printing fluids, comprising the steps of:
1) providing a printing process wherein one or more process printing fluids are in use; wherein said process printing fluids are selected from the group consisting of Fountain Solutions and Web Release Agents;
2) providing a tracer material, capable of being detected fluorometrically, for each process printing fluid of interest, wherein each tracer material, being added to each process printing fluid of interest, has a detectable fluorescent signal;
3) providing one or more fluorometers capable of detecting the fluorescent signals of each tracer material being used within the process printing fluids of interest;
4) locating said one or more fluorometers in any location within the printing process where it is desired to detect the presence or absence of the process printing fluid of interest, except that the location cannot be selected to measure the process printing fluid on the paper itself;
5) using said one or more fluorometers to detect and measure the fluorescent signal of said tracer materials in one or more locations within the printing process;
6) using the detected and measured fluorescent signals of said tracer materials to determine how much of each of the process printing fluids is present in the selected location in the printing process; and optionally
7) adjusting the operating parameters of said printing process such that the amount of process printing fluid present at the locations of interest is optimized.

2. The method of claim 1 in which said process printing fluid is a Fountain Solution.

3. The method of claim 1 in which said process printing fluid is a One-Component Fountain Solution.

4. The method of claim 1 in which said process printing fluid is a Two-Component Fountain Solution.

5. The method of claim 1 in which said process printing fluid is a Web-Release Agent.

6. The method of claim 3 in which said tracer is selected from the group consisting of:
2-anthracenesulfonic acid sodium salt (CAS Registry No. 1610640-4),
1,5-anthracenedisulfonic acid (CAS Registry No. 61736-91-2) and salts thereof,
2,6-anthracenedisulfonic acid (CAS Registry No. 61736-95-6) and salts thereof,
1,8-anthracenedisulfonic acid (CAS Registry No. 61736-92-3) and salts thereof,
anthra[9,1,2-cde]benzo[rst]pentaphene-5,10-diol, 16,17-dimethoxy-, bis(hydrogen sulfate), disodium salt, aka Anthrasol Green IBA (CAS Registry No. 2538-84-3), aka Solubilized Vat Dye,
bathophenanthrolinedisulfonic acid disodium salt (CAS Registry No. 52746-49-3),
1H-benz[de]isoquinoline-5-sulfonic acid, 6-amino-2,3-dihydro-2-(4-methylphenyl)-1,3-dioxo-, monosodium salt, aka Brilliant Acid Yellow 8G (CAS Registry No. 2391-30-2), aka Lissamine Yellow FF, Acid Yellow 7,
benzo[a]phenoxazin-7-ium, 5,9-diamino-, acetate, aka cresyl violet acetate (CAS Registry No. 10510-54-0),
1-ethylquinaldinium iodide (CAS Registry No. 606-53-3),
Keyfluor White ST (CAS Registry No. 4193-55-9), aka Flu. Bright 28,
benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Keyfluor White CN (CAS Registry No. 16470-24-9),
9,9′-biacridinium, 10,10′-dimethyl-, dinitrate, aka Lucigenin (CAS Registry No. 2315-97-1, aka bis-N-methylacridinium nitrate),
1-deoxy-1-(3,4-dihydro-7,8-dimethyl-2,4-dioxobenzo[g]pteridin-10(2H)-yl)-D-ribitol, aka Riboflavin or Vitamin B2 (CAS Registry No. 83-88-5),
2-amino-1-naphthalenesulfonic acid (CAS Registry No. 81-16-3),
5-amino-2-naphthalenesulfonic acid (CAS Registry No. 119-79-9),
7-amino-1,3-naphthalenesulfonic acid, potassium salt (CAS Registry No. 79873-35-1),
5-dimethylamino-1-naphthalenesulfonic acid (CAS Registry No. 4272-77-9),
1-amino-4-naphthalene sulfonic acid (CAS Registry No. 84-86-6),
1-amino-7-naphthalene sulfonic acid (CAS Registry No. 119-28-8),
benzenesulfonic acid, 2,2′-(1,2-ethenediyl)bis[5-(4-phenyl-2H-1,2,3-triazol-2-yl)-, dipotassium salt, aka Phorwite BHC 766 (CAS Registry No. 52237-03-3),
benzenesulfonic acid, 5-(2H-naphtho[1,2-d]triazol-2-yl)-2-(2-phenylethenyl)-, sodium salt, aka Pylaklor White S-15A (CAS Registry No. 6416-68-8),
1,3,6,8-pyrenetetrasulfonic acid, tetrasodium salt (CAS Registry No. 59572-10-0),
quinoline (CAS Registry No. 91-22-5),
xanthylium, 9-(2,4-dicarboxyphenyl)-3,6-bis(diethylamino)-, chloride, disodium salt, aka Rhodamine WT (CAS Registry No. 37299-86-8),
phenazinium, 3,7-diamino-2,8-dimethyl-5-phenyl-, chloride, aka Safranine 0 (CAS Registry No. 477-73-6),
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, aka Sandoz TH-40 (CAS Registry No. 32694-95-4),
xanthylium, 3,6-bis(diethylamino)-9-(2,4-disulfophenyl)-, sodium salt, aka Sulforhodamine B (CAS Registry No. 3520-42-1, aka Acid Red 52),
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, aka Tinopal 5BM-GX (CAS Registry No. 169762-28-1),
benzenesulfonic acid, 2,2′-([1,1′-biphenyl]-4,4′-diyldi-2,1-ethenediyl)bis-, disodium salt aka Tinopal CBS-X (CAS Registry No. 27344-41-8) and
7-benzothiazolesulfonic acid, 2,2′-(1-triazene-1,3-diyldi-4,1-phenylene)bis[6-methyl-, disodium salt, aka Titan Yellow (CAS Registry No. 1829-00-1, aka Thiazole Yellow G).

7. The method of claim 6 in which said tracer is selected from the group consisting of
2-anthracenesulfonic acid sodium salt (CAS Registry No. 16106-40-4),
1,5-anthracenedisulfonic acid (CAS Registry No. 61736-91-2) and salts thereof,
2,6-anthracenedisulfonic acid (CAS Registry No. 61736-95-6) and salts thereof,
b 1,8-anthracenedisulfonic acid (CAS Registry No. 61736-92-3) and salts thereof,
anthra[9,1,2-cde]benzo[rst]pentaphene-5,10-diol, 16,17-dimethoxy-, bis(hydrogen sulfate), disodium salt, aka Anthrasol Green IBA (CAS Registry No. 2538-84-3, aka Solubilized Vat Dye),
bathophenanthrolinedisulfonic acid disodium salt (CAS Registry No. 52746-49-3),
Keyfluor White ST (CAS Registry No. 4193-55-9, aka Flu. Bright 28),
benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Keyfluor White CN (CAS Registry No. 16470-24-9),
1-deoxy-1-(3,4-dihydro-7,8-dimethyl-2,4-dioxobenzo[g]pteridin-10(2H)-yl)-D-ribitol, aka Riboflavin or Vitamin B2 (CAS Registry No. 83-88-5),
benzenesulfonic acid, 2,2′-(1,2-ethenediyl)bis[5-(4-phenyl-2H-1,2,3-triazol-2-yl)-, dipotassium salt, aka Phorwite BHC 766 (CAS Registry No. 52237-03-3),
benzenesulfonic acid, 5-(2H-naphtho[1,2-d]triazol-2-yl)-2-(2-phenylethenyl)-, sodium salt, aka Pylaklor White S-15A (CAS Registry No. 6416-68-8),
1,3,6,8-pyrenetetrasulfonic acid, tetrasodium salt (CAS Registry No. 59572-10-0),
xanthylium, 9-(2,4-dicarboxyphenyl)-3,6-bis(diethylamino)-, chloride, disodium salt, aka Rhodamine WT (CAS Registry No. 37299-86-8),
phenazinium, 3,7-diamino-2,8-dimethyl-5-phenyl-, chloride, aka Safranine 0 (CAS Registry No. 477-73-6),
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, aka Sandoz TH-40 (CAS Registry No. 32694-95-4),
xanthylium, 3,6-bis(diethylamino)-9-(2,4-disulfophenyl)-, sodium salt, aka Sulforhodamine B (CAS Registry No. 3520-42-1, aka Acid Red 52),
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, aka Tinopal 5BM-GX (CAS Registry No. 169762-28-1),
benzenesulfonic acid, 2,2′-([1,1′-biphenyl]-4,4′-diyldi-2,1-ethenediyl)bis-, disodium salt aka Tinopal CBS-X (CAS Registry No. 27344-41-8).

8. The method of claim 7 in which said tracer is selected from the group consisting of
2-anthracenesulfonic acid sodium salt (CAS Registry No. 16106-40-4),
1,5-anthracenedisulfonic acid (CAS Registry No. 61736-91-2) and salts thereof,
2,6-anthracenedisulfonic acid (CAS Registry No. 61736-95-6) and salts thereof,
1,8-anthracenedisulfonic acid (CAS Registry No. 61736-92-3) and salts thereof; and
1,3,6,8-pyrenetetrasulfonic acid, tetrasodium salt (CAS Registry No. 59572-10-0).

9. The method of claim 1 in which both a One-Component Fountain Solution and a Web Release Agent are traced and the same tracer is used in both printing fluids and that tracer is a mixture of the 1,5- and 1,8-isomer of anthracene disulfonic acid, disodium salt.

10. The method of claim 1 in which both a One-Component Fountain Solution and a Web Release Agent are traced and a different tracer is used in each of the printing fluids.

11. The method of claim 1 in which a Two-Component Fountain Solution and a Web Release Agent are traced, and one tracer is used in the first part of the Two-Component Fountain Solution, another tracer is used in the second part of the Two-Component Fountain Solution and a third different tracer is used in the Web Release Agent.

12. The method of claim 1 in which said process printing fluid is a Web Release Agent.

13. The method of claim 12 in which said tracer is selected from the group consisting of
1,5-anthracenedisulfonic acid (CAS Registry No. 61736-91-2) and salts thereof, 2,6-anthracenedisulfonic acid (CAS Registry No. 61736-95-6) and salts thereof, 1,8-anthracenedisulfonic acid (CAS Registry No. 61736-92-3) and salts thereof; and mixtures thereof,
sulfonated amino-stilbene fluorescent brighteners and salts thereof, including, but not limited to:
benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, aka Sandoz CD (CAS Registry No. 16470-24-9), aka Flu. Bright. 220,
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, (CAS Registry No. 32694-95-4), aka Sandoz TH-40,
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, (CAS Registry No. 169762-28-1), aka Tinopal 5BM-GX, and
sulfonated bi-stilbene fluorescent brighteners and salts thereof, including, but not limited to:
4′,4′-bi[stilbene-2,2″′-disulfonate]disodium salt (CAS Registry No. 27344-41-8), aka Tinopal CBS, and
alkylamino-coumarin fluorescent brighteners and salts thereof, including, but not limited to:
4-methyl-7-(diethylamino)-4-methylcoumarin (CAS Registry No. 91-44-1), aka Fluorescent Brightener 52.

14. The method of claim 1 in which said process printing fluid is a Two-Component Fountain Solution wherein one tracer is used to trace the first part of the Two-Component Fountain Solution and a tracer with a different fluorescent signal is used to trace the second part of the Two-Component Fountain Solution.

15. The method of claim 14 in which the tracers are as follows:

| Component | Tracer | Tracer | Tracer | Tracer |
|---|---|---|---|---|
| First | ADSA | PTSA | ADSA | Tinopal CBS-X |
| Component | | | | |
| Second | NDSA | NDSA | Rhodamine WT | Sulforhodamine B |
| Component | | | | |

Wherein, “ADSA” is a compound selected from the group consisting of
1,5-anthracenedisulfonic acid (CAS Registry No. 61736-91-2) and salts thereof,
2,6-anthracenedisulfonic acid (CAS Registry No. 61736-95-6) and salts thereof, 1,8-anthracenedisulfonic acid (CAS Registry No. 61736-92-3) and salts thereof; and mixtures thereof,
“PTSA” refers to 1,3,6,8-pyrenetetrasulfonic acid, tetrasodium salt (CAS Registry No. 59572-10-0).
“NDSA” refers to 1,5-naphthalenedisulfonic acid, disodium salt (hydrate) (CAS Registry No. 1655-29-4), aka 1,5-NDSA hydrate,
“Tinopal CBS-X” refers to benzenesulfonic acid, 2,2′-([1,1′-biphenyl]4,4′-diyldi-2,1-ethenediyl)bis-, disodium salt aka Tinopal CBS-X (CAS Registry No. 27344-41-8),
“Rhodamine WT” refers to xanthylium, 9-(2,4-dicarboxyphenyl)-3,6-bis(diethylamino)-, chloride, disodium salt, aka Rhodamine WT (CAS Registry No. 37299-86-8),
“Sulforhodamine B” refers to xanthylium, 3,6-bis(diethylamino)-9-(2,4-disulfophenyl)-, sodium salt, aka Sulforhodamine B (CAS Registry No. 3520-42-1, aka Acid Red 52).
